(19) United States
(12) Patent Application Publication
(10) Pub. No.: US 2015/0241547 A1
(43) Pub. Date: Aug. 27, 2015

(54) METHOD AND APPARATUS FOR IMPROVING POSITIONING MEASUREMENT UNCERTAINTIES

(71) Applicant: QUALCOMM Incorporated, San Diego, CA (US)

(72) Inventors: Guttorm R. Opshaug, Redwood City, CA (US); Borislav Ristic, San Diego, CA (US); Arash Mirbagheri, San Diego, CA (US); Mayur N. Shah, Millcreek, CA (US); Weihua Gao, San Jose, CA (US)

(73) Assignee: QUALCOMM Incorporated, San Diego, CA (US)

(21) Appl. No.: 14/188,621

(22) Filed: Feb. 24, 2014

(51) Int. Cl. G01S 5/02

(52) U.S. Cl. CPC G01S 5/02

(57) ABSTRACT

Described are an apparatus and a method for increasing an uncertainty associated with an estimated position of the apparatus. Signals transmitted from a plurality of stationary transmitters may be acquired, and a difference in received carrier frequency of the acquired signals may be measured. The lower bound of a speed of a mobile device may be determined based at least in part on the measured difference in received carrier frequency. The uncertainty may be increased based at least in part on the lower bound of the speed.

### BACKGROUND

1. Field

Subject matter disclosed herein relates to position estimation at a mobile device.

2. Information

The position of a mobile device, such as a cellular telephone, may be estimated based on information gathered from various systems. One such system may comprise a mobile device capable of estimating its own position from acquiring signals from terrestrial transmitters using techniques such as observed time difference of arrival (OTDOA) and/or advanced forward link trilateration (AFLT). For instance, a mobile device may acquire signals in sequence and may use the sequentially-acquired signals to estimate its position. If the mobile device is stationary while acquiring signals from different transmitters, the mobile device is not moving between the times of acquisition of signals from different transmitters and therefore range measurements are not affected. If, on the other hand, the mobile device is in motion while acquiring signals transmitted from different transmitters, the mobile device may move between the times of acquisition of signals and therefore possibly affect range measurements. Depending on a speed with which the mobile device is moving, an estimate of a location of the mobile device that is computed based on these acquired signals may be inherently uncertain. Some techniques, such as OTDOA may use uncertainty in estimating the position of a mobile device. Further, uncertainty data may be required to be provided for emergency calls, among other things.

### BRIEF DESCRIPTION OF THE FIGURES

Non-limiting and non-exhaustive examples will be described with reference to the following figures, wherein like reference numerals refer to like parts throughout the various figures.

FIG. 1 is a schematic block diagram depicting an example technique for increasing an uncertainty associated with an estimated position for a mobile device.

FIG. 2 is a flow diagram of a process performed at a mobile device according to an embodiment.

FIG. 3 is a schematic block diagram of a mobile device according to an embodiment.

### SUMMARY

Briefly, particular implementations are directed to a method at a mobile device comprising: acquiring signals transmitted from a plurality of stationary transmitters. The method also comprises measuring a difference in received fractional carrier frequency offsets between acquired signals transmitted from at least one pair of said stationary transmitters. The method includes determining a lower bound of a speed of said mobile device based, at least in part, on said measured difference. And the method includes increasing an uncertainty associated with an estimated position of the mobile device based, at least in part, on said determined lower bound.

Another implementation is directed to a mobile device comprising: a receiver to acquire signals transmitted from a plurality of stationary transmitters; and a processor to: measure a difference in received frequency between acquired signals transmitted from a first pair of said stationary transmitters; determine a lower bound of a speed of said mobile device based, at least in part, on said measured difference; and increase an uncertainty associated with an estimated position of said mobile device based, at least in part, on said determined lower bound.

Another implementation is related to an apparatus comprising: means for acquiring signals transmitted from a plurality of stationary transmitters; means for measuring a difference in received frequency between signals acquired from one of the plurality of stationary transmitters with signals acquired from at least a second of said plurality of stationary transmitters; means for determining a lower bound of a speed of said mobile device based, at least in part, on said measured difference; and means for increasing an uncertainty associated with an estimated position of said apparatus based, at least in part, on said determined lower bound.

It should be understood that the aforementioned implementations are merely example implementations, and that claimed subject matter is not necessarily limited to any particular aspect of these example implementations.

### DETAILED DESCRIPTION

Some example techniques are presented herein which may be implemented in various method and apparatuses in a mobile device and a location server to enable particular techniques for estimating locations of mobile devices.

In some networks, such as, for example, Long Term Evolution (LTE) networks, measurements of times of arrival of signals (e.g., positioning reference signals (PRSs)) transmitted by transmitters such as, for example, by base stations (e.g., eNode-B), can be used for positioning. In one embodiment, PRSs may be transmitted in short bursts referred to as PRS occasions. The accuracy of estimating a location using such techniques may rely at least in part on a duration of PRS occasions, a spacing of PRS occasions, a distance traveled by a mobile device between PRS occasions and/or times of PRS acquisition, and a rate of speed at which a mobile device may be traveling, among other things. Further, in some cases, muting patterns, or bit masks of PRS occasions, may further increase the effective spacing of occasions.

As mentioned above, a position of a mobile device, such as a cellular telephone, may be estimated based on information gathered from various systems. One such system may comprise a cellular telephone capable of estimating its own position based at least in part on signals acquired from one or more terrestrial transmitters using techniques such as observed time difference of arrival (OTDOA) and/or advanced forward link trilateration (AFLT), by way of example. OTDOA measurements typically comprise a collection of a plurality of PRS occasions spaced over different intervals in time and/or acquired in a sequential manner. In one example, the time of acquisition of PRS occasions may be spaced 160, 320, 640, and/or 1280 ms apart. Intra-frequency OTDOA sessions may comprise acquiring PRS occasions from up to 25 base stations or cells. In some embodiments, a plurality of occasions may be needed in order to estimate a location of a mobile device in an OTDOA session. For instance, in one embodiment a minimum of 7 PRS occasions may be needed to estimation a location of a mobile device in an OTDOA session.

In one embodiment, an estimated location or position fix of a mobile device is returned from a collection of acquired PRS occasions even though the acquisition of respective PRS occasions may have been made in different physical locations due to movement of the mobile device. Thus, for example, in one embodiment, if the time of acquisition of a collection of PRS occasions is spaced out over 4 seconds, a user at highway speed may have traveled 120 m (e.g., a vehicle traveling at approximately 30 m/s, or approximately 67 miles per hour, will travel approximately 120 meters in 4 seconds). Because, as is explained in reference to one of the preceding embodiments, a position fix may be returned in response to a plurality of PRS occasions, an uncertainty value (referred to herein alternatively as “uncertainty” and “measurement uncertainty”) may be associated with and/or assigned to the position fix. The present disclosure proposes increasing the measurement uncertainty of the estimated location of a mobile device as a function of speed of the mobile device and time elapsed from time-of-measurement to time-of-fix to account for user motion. Thus, for example, by increasing an uncertainty associated with an estimated location for a mobile device, the resulting increased uncertainty value may be used to refine a position fix, for emergency service-related localization, among other things. For instance, the uncertainty value may be transmitted along with an estimated location for a device in relation to emergency services. In another instance, the uncertainty value may be used to update an estimated location of the mobile device. In case outlined above, for example, the uncertainty value may be used to update the estimated location of the mobile device by 120 meters. Of course, these examples are intended to merely illustrate sample uses for the claimed subject matter, and are not intended to be understood restrictively.

In operation, measurement uncertainty may be used in order to estimate and/or display a location of a mobile device. For example, in one embodiment, uncertainty may be taken into account when determining an estimated location of a mobile device. In one case, a mobile device may display a location and/or changes in location of the mobile device based on an algorithm based at least in part on measurement uncertainty. Further, the mobile device may use and/or transmit the measurement uncertainty in relation to or conjunction with calls to, for example, emergency services such as 911, to name one example.

In one embodiment, a mobile device may be capable of generating an indication of speed of the mobile device, and the indication of speed may be used to inflate or increase measurement uncertainty. The speed indicator in one case may be generated by comparing a spread of Doppler measurements from different base stations or cells. In another case, Doppler measurements may be generated from direct observations of frequency offsets based on PRS or cell-specific reference signal (CRS) occasions. Alternatively, Doppler measurements may be estimated by determining a change in PRS or CRS time of arrivals over time (e.g., change in phase per unit time). In another embodiment, the speed indicator may be external to the mobile device, such as, for example, from a global navigation satellite system (GNSS), odometer, and radar, to name but a few examples.

In one embodiment, a mobile device may comprise a speed indicator to estimate a lower bound of a true speed of the mobile device. For instance, depending on a particular use case, such as when the mobile device is travelling at a high rate of speed, among other things, it may be advantageous to inflate the indication of speed of the mobile device beyond the initial indication before using the speed in an uncertainty calculation.

In some location determination techniques, a mobile device may acquire signals from three or more terrestrial based transmitters which are fixed at known locations. Based at least in part on the acquired signals, ranges from the current location of the mobile device to the transmitters may be measured. The measured ranges may then enable computation of an estimated location of the mobile device using trilateration techniques, by way of example. In particular implementations, a mobile device may not acquire signals from different transmitters simultaneously. Instead, the mobile device may acquire signals from different transmitters, one at a time, in sequence. If the mobile device is stationary while acquiring signals from different transmitters, the mobile device is not moving between acquisition of signals from different transmitters, and therefore, range measurements are not affected by motion. In such a case, a location of the mobile device may then be reliably estimated based, at least in part, on the acquired signals.

On the other hand, if the mobile device is in motion while acquiring signals transmitted from different transmitters, such as, for example, sequential PRS occasions, the mobile device moves between acquisitions of signals, and therefore, the movement may possibly affect range measurements, among other things. As such, different range measurements used for computing a position fix may be obtained at instances where the mobile device is at different locations relative to other measurements. Depending on a speed with which such a mobile device is moving, an estimate of a location of the mobile device computed based on these acquired signals may be inherently uncertain.

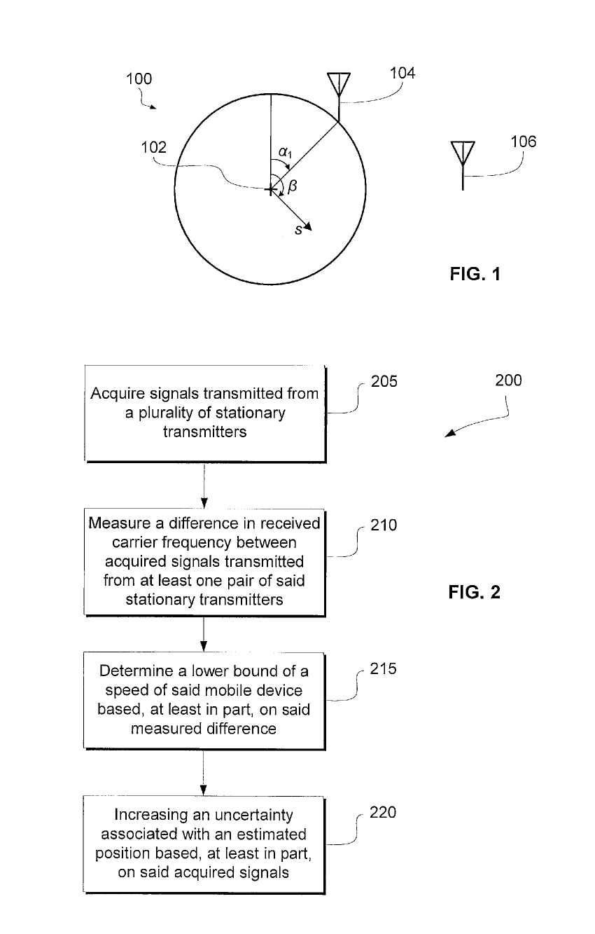

FIG. 1 illustrates a mobile device 102 in motion with speed s, at an angle β with respect to an arbitrary reference frame. A first transmitter 106 is located at an angle of 90 degrees with respect to the reference frame, and second transmitter 104 is located at an angle α₁ with respect to the reference frame: In one embodiment, the transmitters may be frequency-locked to a common frequency source, such as, for example, a GPS or satellite positioning system (SPS) source, among other things. However, the present application also contemplates functionality spanning a plurality of frequencies such as, for example, a case where a mobile device uses a plurality of PRS occasions from a plurality of different carriers and spanning a plurality of different frequencies.

In operation, mobile device 102 may be in motion defined by a velocity vector comprising a speed s. Mobile device 102 may receive one or more signals from first and second transmitters 106 and/or 104. In this example, the first and second transmitters 106 and 104 may emit signals at a frequency f₁ and f₂, respectively. Further, the signals acquired by mobile device 102 may be generally referred to as having a frequency f₀. The received one or more signals may enable mobile device 102 to determine an approximate position of mobile device 102. For example, in one embodiment, mobile device 102 may be capable of basing the determined approximate position of mobile device 102 at least in part on an uncertainty value or function. In one case, mobile device 102 may be capable of using the Doppler Effect at least in part to determine an uncertainty of a position of mobile device 102. For example, mobile device 102 may be in motion and may observe a Doppler offset of the received one or more signals. Mobile device 102 may determine an uncertainty value based at least in part on an observed Doppler offset of the received one or more signals. The uncertainty value may be represented as an expression, a region, and/or an array, among other things. Mobile device 102 may use the uncertainty value at least in part in determining and/or updating a position of mobile device 102, among other things. As would be readily understood by one of ordinary skill in the art, the foregoing is merely presented to illustrate a general concept and is not to be taken in a restrictive sense.

In one example, a Doppler offset may be observed by mobile device 102 with regards to signals acquired from first transmitter 106 as defined by

$$Δ {f}_{1} = \frac{{f}_{0}}{c} s \cdot sin ( β )$$

A Doppler offset may also be observed by mobile device 102 with regards to signals acquired from second transmitter 104 as defined by

$$Δ {f}_{2} = \frac{{f}_{0}}{c} s \cdot cos ( β - {α}_{1} )$$

where f₀ represents a center frequency of signals transmitted from first transmitter 106 and second transmitter 104, and c is the speed of light. In a particular example implementation, signals transmitted by first and second transmitters 106 and 104 may comprise positioning reference signals (PRS). It should be understood, however, that the foregoing PRSs are merely examples of possible signals that may be used according to the present disclosure.

In one embodiment second transmitter 104 and first transmitter 106 may emit one or more signals that are transmitted on different nominal frequencies f₁ and f₂. Calculations may be done in terms of fractional carrier frequency offset, fcfo, (e.g., normalized Doppler) instead of absolute Doppler, and may be represented by:

$${fcfo}_{1} = \frac{Δ {f}_{1}}{{f}_{1}} = \frac{s}{c} \cdot sin ( β )$$

$${fcfo}_{2} = \frac{Δ {f}_{2}}{{f}_{2}} = \frac{s}{c} \cdot cos ( β - {α}_{1} )$$

In at least one embodiment, observations of mobile device 102 may be tied to the same fundamental indication of frequency (e.g. from a device clock (XO)).

In one embodiment, observation of an indication of a Doppler offset at mobile device 102 may, for example, be enabled by measuring a frequency offset between an incoming signal and an expected frequency value generated from a local clock source of mobile device 102. In another embodiment, and as already mentioned above, an indication of a Doppler offset may be found by calculating a time-difference of pseudorange and/or phase measurements from signals acquired from stationary transmitters, such as, for example, first and second transmitters 106 and 104. While the notion of absolute frequency at mobile device 102 may be off by some amount from truth, the short term stabilities of any of several device clocks (XOs) of those known to those of ordinary skill in the art may be sufficient for functionality contemplated by the present disclosure. In one embodiment, Doppler observations relative to different transmitters (e.g., first and second transmitters 106 and 104) that are concurrent or close in time to each other can be assumed to have a common-mode absolute frequency offset. In this case, using differences between measurements from different cells may minimize the impact of device clock errors. As will be seen hereafter, differential Doppler offsets may be calculated between pairs of transmitters. However, other embodiments are possible, such as using max to min offset of measurements, by way of example.

In one embodiment, Relative Doppler offset compared to first transmitter 106 may be represented by:

$$Δ {f}_{2} - Δ {f}_{1} = \frac{{f}_{0}}{c} s \cdot ( cos ( β - {α}_{1} ) - sin ( β ) )$$

$$s \cdot ( cos ( β - {α}_{1} ) - sin ( β ) ) = \frac{Δ {f}_{2} - Δ {f}_{1}}{{f}_{0}} \cdot c$$

In this case, the trigonometric function may be bounded by [−1,1], such that a lower bound on speed may be expressed as follows:

$$s \geq abs ( \frac{Δ {f}_{2} - Δ {f}_{1}}{{f}_{0}} \cdot c )$$

In another embodiment, a user may make measurements on different nominal carrier frequencies, f₁ and f₂. The Doppler offsets may be normalized in this case relative to each respective carrier frequency and may lead to the following equation:

$${fcfo}_{2} - {fcfo}_{1} = \frac{Δ {f}_{2}}{{f}_{2}} - \frac{Δ {f}_{1}}{{f}_{1}} = \frac{s}{c} \cdot cos ( β - {α}_{1} ) - \frac{s}{c} \cdot sin ( β )$$

$$Thus , \\ s \cdot ( cos ( β - {α}_{1} ) - sin ( β ) ) = c \cdot ( {fcfo}_{2} - {fcfo}_{1} )$$

Again, the trigonometric function is bounded by a range of [−1, 1], such that a lower bound of speed may be expressed as follows:

s≧abs(c·(fcfo₂−fcfo₁))

In one implementation, observing indications of Doppler with regards to signals from a multitude of transmitters (e.g., transmitters illustratively numbered 1, 2, 3, . . . N−1, N) from typically different directions may comprise a multitude of frequencies (e.g., f₁, f₂, f₃, . . . f_{N-1}, f_{N}), may enable the construction of a set of inequality equations for all possible combinations of transmitter pairs to provide the following expression of an estimated lower bound on speed:

$$s \cdot [ \begin{matrix}1 \\ 1 \\ ⋮ \\ 1\end{matrix} ] \geq [ \begin{matrix}abs ( \frac{Δ {f}_{2} - Δ {f}_{1}}{{f}_{0}} \cdot c ) \\ abs ( \frac{Δ {f}_{3} - Δ {f}_{1}}{{f}_{0}} \cdot c ) \\ ⋮ \\ abs ( \frac{Δ {f}_{N} - Δ {f}_{1}}{{f}_{0}} \cdot c ) \\ abs ( \frac{Δ {f}_{3} - Δ {f}_{2}}{{f}_{0}} \cdot c ) \\ ⋮ \\ abs ( \frac{Δ {f}_{N} - Δ {f}_{2}}{{f}_{0}} \cdot c ) \\ ⋮ \\ abs ( \frac{Δ {f}_{N} - Δ {f}_{N - 1}}{{f}_{0}} \cdot c )\end{matrix} ]$$

Where ultimately,

$$s \geq max ( \begin{matrix}abs ( \frac{Δ {f}_{2} - Δ {f}_{1}}{{f}_{0}} \cdot c ) \\ abs ( \frac{Δ {f}_{3} - Δ {f}_{1}}{{f}_{0}} \cdot c ) \\ ⋮ \\ abs ( \frac{Δ {f}_{N} - Δ {f}_{1}}{{f}_{0}} \cdot c ) \\ abs ( \frac{Δ {f}_{3} - Δ {f}_{2}}{{f}_{0}} \cdot c ) \\ ⋮ \\ abs ( \frac{Δ {f}_{N} - Δ {f}_{2}}{{f}_{0}} \cdot c ) \\ ⋮ \\ abs ( \frac{Δ {f}_{N} - Δ {f}_{N - 1}}{{f}_{0}} \cdot c )\end{matrix} )$$

Similarly, for an embodiment employing fcfo, the following expression may be used to represent a lower bound on speed:

$$s \cdot [ \begin{matrix}1 \\ 1 \\ ⋮ \\ 1\end{matrix} ] \geq [ \begin{matrix}abs ( ( {fcfo}_{2} - {fcfo}_{1} ) \cdot c ) \\ abs ( ( {fcfo}_{3} - {fcfo}_{1} ) \cdot c ) \\ ⋮ \\ abs ( ( {fcfo}_{N} - {fcfo}_{1} ) \cdot c ) \\ abs ( ( {fcfo}_{3} - {fcfo}_{2} ) \cdot c ) \\ ⋮ \\ abs ( ( {fcfo}_{N} - {fcfo}_{2} ) \cdot c ) \\ ⋮ \\ abs ( ( {fcfo}_{N} - {fcfo}_{N - 1} ) \cdot c )\end{matrix} ]$$

Where ultimately,

$$s \geq max ( \begin{matrix}\begin{matrix}\begin{matrix}\begin{matrix}\begin{matrix}\begin{matrix}\begin{matrix}\begin{matrix}abs ( ( {fcfo}_{2} - {fcfo}_{1} ) \cdot c ) \\ abs ( ( {fcfo}_{3} - {fcfo}_{1} ) \cdot c )\end{matrix} \\ ⋮\end{matrix} \\ abs ( ( {fcfo}_{N} - {fcfo}_{1} ) \cdot c )\end{matrix} \\ abs ( ( {fcfo}_{3} - {fcfo}_{2} ) \cdot c )\end{matrix} \\ ⋮\end{matrix} \\ abs ( ( {fcfo}_{N} - {fcfo}_{2} ) \cdot c )\end{matrix} \\ ⋮\end{matrix} \\ abs ( ( {fcfo}_{N} - {fcfo}_{N - 1} ) \cdot c )\end{matrix} )$$

As alluded to above, in one embodiment, an estimated location of mobile device 102 may be computed based, at least in part, on ranges to three or more transmitters measured from signals acquired from the transmitters. Based, at least in part, on a value of an expression of a lower bound on speed of a mobile device 102, an uncertainty value associated with the estimated location may be computed. In one example, the computed uncertainty value may be used, at least in part, to update and/or otherwise alter an estimated location of mobile device 102. In one embodiment, the application of uncertainty based, at least in part, on Doppler indicators may consider indications of Doppler offset where the following is true:

(Δfᵢ−Δfⱼ)≧k1·(Uncᵢ+Uncⱼ)

or

(Δfᵢ−Δfⱼ)≧k2−sqrt(Uncᵢ²+Uncⱼ²)

Or may modify the measurements as follows:

$$( Δ {f}_{i} - Δ {f}_{j} ) -> \{ \begin{matrix}\begin{matrix}abs ( Δ {f}_{i} - Δ {f}_{j} ) - k 1 \cdot ( {Unc}_{i} + {Unc}_{j} ) if \\ abs ( Δ {f}_{i} - Δ {f}_{j} ) - k 1 \cdot ( {Unc}_{i} + {Unc}_{j} ) > 0\end{matrix} \\ 0 otherwise\end{matrix}$$

In the preceding equations, fᵢ and fⱼ refer to the frequency of signals transmitted by a transmitter i and j as seen by a mobile device, such as mobile device 102 and Uncₓ represents an uncertainty measurement or function. The estimate of uncertainty may be in part based on a signal-to-noise ratio of a Doppler measurement. Similar considerations may be made using uncertainty combination in variance-domain (RSS). The k1 or k2 parameters could be used to tune the speed indicator depending on the desired level of confidence of motion. As one of ordinary skill in the art would appreciate, the foregoing discussion is provided to further illustrate the principles and concepts discussed herein. These examples are not to be taken in a restrictive sense. Indeed, the present disclosure contemplates any number of embodiments consistent with the principles and functionality disclosed.

Additionally, by way of example, in an embodiment employing fcfo, we may only consider measurements where the following is true:

$$( {fcfo}_{i} - {fcfo}_{j} ) \geq k 1 \cdot ( \frac{{Unc}_{i}}{{f}_{k}} + \frac{{Unc}_{j}}{{f}_{l}} )$$

$$or \\ ( {fcfo}_{i} - {fcfo}_{j} ) \geq k 2 \cdot sqrt ( {( \frac{{Unc}_{i}}{{f}_{k}} )}^{2} + {( \frac{{Unc}_{j}}{{f}_{l}} )}^{2} )$$

where fcfoᵢ_{_{—}} represents an fcfo measurement made on carrier frequency fₖ and fcfoⱼ_{_{—}} represents an fcfo measurement made on frequency fₗ. Uncᵢ_{_{—}} and Uncⱼ represent similar Doppler measurement uncertainties to those discussed above.

Similarly, in one embodiment, the measurements that may factor into the speed bounding estimate may be modified as follows:

$$( {fcfo}_{i} - {fcfo}_{j} ) -> \{ \begin{matrix}\begin{matrix}abs ( {fcfo}_{i} - {fcfo}_{j} ) - k 1 \cdot ( \frac{{Unc}_{i}}{{f}_{k}} + \frac{{Unc}_{j}}{{f}_{l}} ) if \\ abs ( {fcfo}_{i} - {fcfo}_{j} ) - k 1 \cdot ( \frac{{Unc}_{i}}{{f}_{k}} + \frac{{Unc}_{j}}{{f}_{l}} ) > 0\end{matrix} \\ 0 otherwise\end{matrix}$$

A variance-domain equivalent to the above may be represented as:

$$( {fcfo}_{i} - {fcfo}_{j} ) -> \{ \begin{matrix}abs ( {fcfo}_{i} - {fcfo}_{j} ) - k 2 \cdot sqrt ( {( \frac{{Unc}_{i}}{{f}_{k}} )}^{2} + {( ( \frac{{Unc}_{j}}{{f}_{l}} ) )}^{2} ) if abs ( {fcfo}_{i} - {fcfo}_{j} ) - k 2 \cdot sqrt ( ( \text{?} \\ 0 otherwise\end{matrix} \\ \text{?} \text{indicates text missing or illegible when filed}$$

FIG. 2 illustrates a method 200 for determining uncertainties for a mobile device. At block 205, signals are acquired that were transmitted from a plurality of stationary transmitters. Signals may be acquired at a mobile device comprising, for example, a cellular telephone or a tablet, to name a few examples. At block 210 comprises measuring a difference in received carrier frequency between acquired signals transmitted from at least one pair of said stationary transmitters. In one example, the acquired signals may be received by a processor of a mobile device, and the processor may be capable of data processing including, but not limited to, measuring a difference in received carrier frequency. At block 215, a lower bound of a speed of said mobile device may be determined based, at least in part, on the measured difference from block 210. In one case, the determination of a lower bound of a speed of a mobile device may be arrived at based at least in part on signals processed in a processor of the mobile device. Block 220 comprises increasing an uncertainty associated with an estimated position of the mobile device based, at least in part, on said acquired signals. The preceding method is provided to illustrate the principles and functionality disclosed in the present disclosure and is not intended to be taken in a restrictive sense. As one of ordinary skill in the art would readily understand, the present disclosure contemplates any number of different additional implementations.

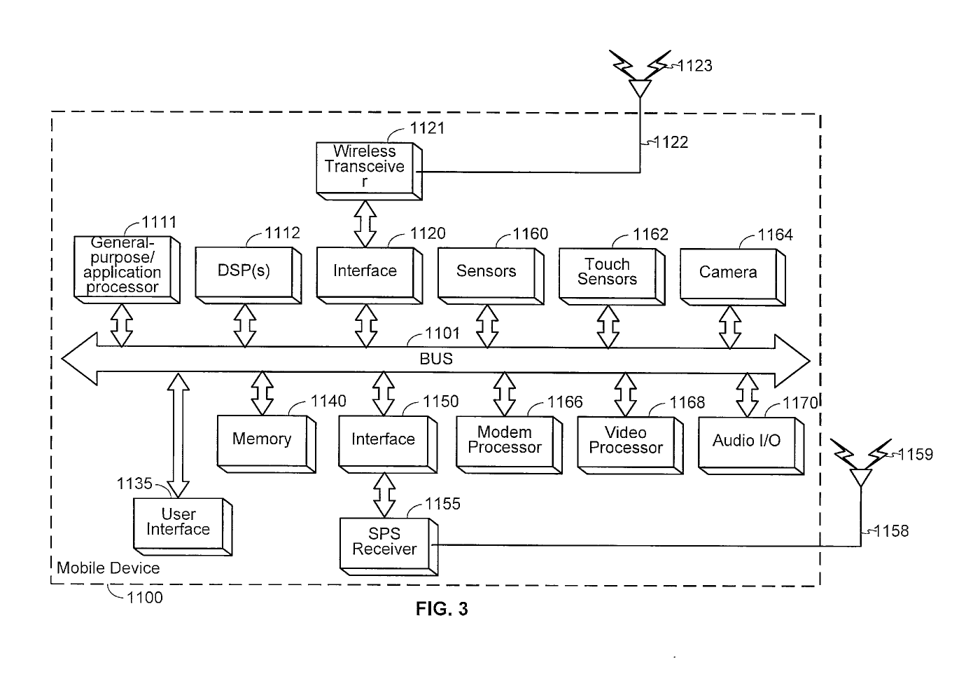

FIG. 3 is a schematic diagram of a mobile device according to an embodiment. Mobile device 102 (FIG. 1) may comprise one or more features of mobile device 1100 shown in FIG. 3. In certain embodiments, mobile device 1100 may also comprise a wireless transceiver 1121 which is capable of transmitting and receiving wireless signals 1123 via wireless antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and wireless antennas 1122 to enable transmitting and/or receiving signals according to a corresponding multiple wireless communication standards such as, for example, versions of IEEE Std. 802.11, CDMA, WCDMA, LTE, UMTS, GSM, AMPS, Zigbee and Bluetooth, just to name a few examples. In a particular implementation, wireless transceiver 1121 in combination with wireless antenna 1122 may be configured to perform actions set forth at block 205 (e.g., to receive a signals from a plurality of stationary transmitters) of FIG. 2, by way of example.

Mobile device 1100 may also comprise SPS receiver 1155 capable of receiving and acquiring SPS signals 1159 via SPS antenna 1158. SPS receiver 1155 may also process, in whole or in part, acquired SPS signals 1159 for estimating a location of mobile device 1000. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals (e.g., signals acquired from wireless transceiver 1121) for use in performing positioning operations may be performed in memory 1140 or registers (not shown). As such, general-purpose processor(s) 1111, memory 1140, DSP(s) 1112 and/or specialized processors may provide a location engine for use in processing measurements to estimate a location of mobile device 1100. In a particular implementation, general-purpose processor(s) 1111, memory 1140, DSP(s) 1112 and/or specialized processors may be configured to (a) measure a difference in received carrier frequency between acquired signals transmitted from at least one pair of said stationary transmitters, as set forth in block 210, (b) determine a lower bound of a speed of said mobile device based, at least in part, on said measured difference, as set forth in block 215, and/or (c) increase an uncertainty associated with an estimated position based, at least in part, on said acquired signals, as set forth in block 220 of FIG. 2.

Also shown in FIG. 3, mobile device 1100 may comprise digital signal processor(s) (DSP(s)) 1112 connected to the bus 1101 by a bus interface 1110, general-purpose processor(s) 1111 connected to the bus 1101 by a bus interface 1110 and memory 1140. Bus interface 1110 may be integrated with the DSP(s) 1112, general-purpose processor(s) 1111 and memory 1140. In various embodiments, functions may be performed in response execution of one or more machine-readable instructions stored in memory 1140 such as on a computer-readable storage medium, such as RAM, ROM, FLASH, or disc drive, just to name a few example. The one or more instructions may be executable by general-purpose processor(s) 1111, specialized processors, or DSP(s) 1112. Memory 1140 may comprise a non-transitory processor-readable memory and/or a computer-readable memory that stores software code (programming code, instructions, etc.) that are executable by processor(s) 1111 and/or DSP(s) 1112 to perform functions described herein.

Also shown in FIG. 3, a user interface 1135 may comprise any one of several devices such as, for example, a speaker, microphone, display device, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112 or general purpose processor 1111 in response to action from a user. Similarly, applications hosted on mobile device 1100 may store analog or digital signals on memory 1140 to present an output signal to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated camera device 1164 for capturing still or moving imagery. Camera device 1164 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression or manipulation of signals representing captured images. Additionally, video processor 1168 may decode/decompress stored image data for presentation on a display device (not shown) on mobile device 1100.

Mobile device 1100 may also comprise sensors 1160 coupled to bus 1101 which may include, for example, inertial sensors and environment sensors. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). Environment sensors of mobile device 1100 may comprise, for example, temperature sensors, barometric pressure sensors, ambient light sensors, camera imagers, microphones, just to name few examples. Sensors 1160 may generate analog or digital signals that may be stored in memory 1140 and processed by DPS(s) or general purpose application processor 1111 in support of one or more applications such as, for example, applications directed to positioning or navigation operations.

In a particular implementation, mobile device 1100 may comprise a dedicated modem processor 1166 capable of performing baseband processing of signals received and downconverted at wireless transceiver 1121 or SPS receiver 1155. Similarly, modem processor 1166 may perform baseband processing of signals to be upconverted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect.

As used herein, the term “mobile device” refers to a device that may from time to time have a position location that changes. The changes in position location may comprise changes to direction, distance, orientation, etc., as a few examples. In particular examples, a mobile device may comprise a cellular telephone, wireless communication device, user equipment, laptop computer, other personal communication system (PCS) device, personal digital assistant (PDA), personal audio device (PAD), portable navigational device, and/or other portable communication devices. A mobile device may also comprise a processor and/or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions or information. Such storage devices may comprise any one of several media types including, for example, magnetic, optical or semiconductor storage media. Such storage devices may also comprise any type of long term, short term, volatile or non-volatile memory devices. However, these are merely examples of a storage medium, and claimed subject matter is not limited in these respects.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, or any combination of the above networks, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. 4G Long Term Evolution (LTE) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (CDMA) cellular communication protocol, for example, and the femtocell may provide the mobile device access to a larger cellular telecommunication network by way of another broadband network such as the Internet.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method at a mobile device comprising:
acquiring signals transmitted from a plurality of stationary transmitters;
measuring a difference in received fractional carrier frequency offsets between acquired signals transmitted from at least one pair of said stationary transmitters;
determining a lower bound of a speed of said mobile device based, at least in part, on said measured difference; and
increasing an uncertainty associated with an estimated position of the mobile device based, at least in part, on said determined lower bound.

2. The method of claim 1, wherein said estimated position is determined based, at least in part, on said acquired signals.

3. The method of claim 1, wherein said estimated position is computed using observed difference of time of arrival (OTDOA).

4. The method of claim 1, wherein said acquired signals comprise positioning reference signals transmitted at a same frequency.

5. The method of claim 1 further wherein said estimated position is based at least in part on ranges to three or more of said plurality of stationary transmitters.

6. The method of claim 1 further comprising updating said estimated position based at least in part on said uncertainty.

7. The method of claim 6 further comprising transmitting said updated estimated position and/or said uncertainty.

8. A mobile device comprising:
a receiver to acquire signals transmitted from a plurality of stationary transmitters; and
a processor to:
measure a difference in received frequency between acquired signals transmitted from a first pair of said stationary transmitters;
determine a lower bound of a speed of said mobile device based, at least in part, on said measured difference; and
increase an uncertainty associated with an estimated position of said mobile device based, at least in part, on said determined lower bound.

9. The mobile device of claim 8 further wherein said processor is also to measure a difference in received frequency between acquired signals from a second pair of said stationary transmitters.

10. The mobile device of claim 9 wherein said first pair of said stationary transmitters transmits at a first frequency and said second pair of said stationary transmitters transmits at a second frequency different from said first frequency.

11. The mobile device of claim 10 wherein said first pair of said stationary transmitters are of a first carrier and said second pair of said stationary transmitters are of a second carrier.

12. The mobile device of claim 8 wherein said estimated position is based at least in part on ranges to three or more of said plurality of stationary transmitters.

13. The mobile device of claim 8 wherein said processor is further to enable displaying the estimated position of the mobile device based at least in part on said uncertainty.

14. An apparatus comprising:
means for acquiring signals transmitted from a plurality of stationary transmitters;
means for measuring a difference in received frequency between signals acquired from one of said plurality of stationary transmitters with signals acquired from at least a second of said plurality of stationary transmitters;
means for determining a lower bound of a speed of said apparatus based, at least in part, on said measured difference; and
means for increasing an uncertainty associated with an estimated position of said apparatus based, at least in part, on said determined lower bound.

15. The apparatus of claim 14, wherein said estimated position is determined based, at least in part, on said acquired signals.

16. The apparatus of claim 14, wherein said estimated position is computed using observed difference of time of arrival (OTDOA).

17. The apparatus of claim 14, wherein said acquired signals comprise positioning reference signals transmitted at a same frequency.

18. The apparatus of claim 14 further wherein said estimated position is based at least in part on ranges to three or more of said plurality of stationary transmitters.

19. The apparatus of claim 14 further comprising means for updating said estimated position based at least in part on said uncertainty.

20. The apparatus of claim 14, wherein said measuring a difference in received frequency comprises measuring a difference in received fractional carrier offsets between signals acquired from said one and said second of said plurality of stationary transmitters.
